(19) United States
(12) Patent Application Publication
(10) Pub. No.: US 2017/0146181 A1
(43) Pub. Date: May 25, 2017

(54) SHAFT AND PIVOT DEVICE

(71) Applicant: SYNCMOLD ENTERPRISE CORP., New Taipei City (TW)

(72) Inventors: Tung-Chiung CHEN, New Taipei City (TW); Chih-Hsin CHOU, New Taipei City (TW)

(21) Appl. No.: 15/331,383

(22) Filed: Oct. 21, 2016

(30) Foreign Application Priority Data
Nov. 20, 2015 (TW) 104218632

(51) Int. Cl. F16M 11/20; F16C 11/04

(52) U.S. Cl. CPC F16M 11/2021; F16C 11/04

(57) ABSTRACT

A shaft and a pivot device are provided. The shaft includes a body and at least one protrusion forming on a first end of the body. The body and the protrusion are forming an end cross-section along a radial direction. The pivot device includes the shaft and an assembly structure. The assembly structure has at least one positioning hole for the shaft disposed through. The positioning hole is complementary to the non-circular end cross-section.

### CROSS REFERENCE TO RELATED APPLICATION

This application claims the benefits of the Taiwan Patent Application Serial Number 104218632, filed on Nov. 20, 2015, the subject matter of which is incorporated herein by reference.

### BACKGROUND OF THE INVENTION

1. Field of the Invention

The present invention relates to a shaft and a pivot device, more particularly, to a shaft and a pivot device used for a supporting frame.

2. Description of Related Art

A conventional pivot device as disclosed in Taiwan Patent No.M458072 is assembled on a base to pivot with a supporting arm. The base includes a shaft base. The pivot device comprises a shaft having two opposite cutting surfaces, and each of two side panels of the shaft base is defined with an axle hole which is complementary to a cross-section of the shaft. The shaft sequentially penetrates through the axle holes so that the shaft is disposed on the shaft base and is not able to rotate. An end of the supporting arm has a circular axle hole mounted to the shaft so that the supporting arm is rotatable along the shaft.

A cylinder is subjected to a cutting process to form the two opposite cutting surfaces in manufacturing the shaft. That is to say, shape of the cross-section of the shaft is oval. However, the manufacture of the conventional pivot device becomes more complicated because of applying cutting manufacturing processes to the shaft. Moreover, the disadvantage of the shaft with oval cross-section is that the assembly direction needs to be well aligned when the shaft penetrates through the axle holes. That is to say, the edge of the shaft should be aligned to the edge of the axle holes during the assembling process. If locations of the axle holes are deviated to each other or a tolerance exists between the axle holes, it will be not easy for the shaft aligning and penetrating through the axle holes. The assembling time of the pivot device will be extended because of the above mentioned aligning processes.

Accordingly, developing a new shaft and a pivot device is urgently needed in this field.

### SUMMARY OF THE INVENTION

The object of the present invention is to provide a shaft and a pivot device comprising the same. The shaft comprises a body with simplified shape so as to reduce the manufacturing processes and the assembling time of the pivot device

To achieve the abovementioned objects, a shaft for being disposed through with an assembly structure having at least one positioning hole is disclosed in the present invention. The shaft comprises a body, a head and at least one protrusion. The body extends along an axial direction and has a first end. The body has a circular body cross-section along a radial direction, which is perpendicular to the axial direction. The head connects with the first end and has a head cross-section along the radial direction, wherein the head cross-section is larger than the body cross-section. The protrusion is formed on the body and adjacent to the first end, wherein the body and the protrusion form an end cross-section along the radial direction, and the end cross-section is non-circular and the assembly structure has at least one positioning hole for the shaft disposed through, wherein the at least one positioning hole and the end cross-section are complementary.

In one embodiment, the shaft includes a plurality of the protrusions. The protrusions are connected with the head.

In addition, the present invention further discloses a pivot device comprises a shaft, an assembly structure and a rotating member. The shaft comprises a body, a head and at least on protrusion. The body extends along an axial direction and has a first end. The body has a circular body cross-section along a radial direction, which is perpendicular to the axial direction. The head connects with the first end and has a head cross-section along the radial direction, wherein the head cross-section is larger than the body cross-section. The protrusion is formed on the body and adjacent to the first end, wherein the body and the protrusion form a non-circular end cross-section along the radial direction. The assembly structure has at least one positioning hole for the shaft to be disposed through, wherein the at least one positioning hole and the end cross-section are complementary. The rotating member is pivoted on the body to rotate along the body to an angle with respect to the assembly structure.

Preferably, the assembly structure is a shaft base, a pad, or the combination thereof The shaft includes a plurality of protrusions. In a preferred embodiment of the present invention, the pivot device further comprises a torsional spring being pivoted on the body, wherein two ends of the torsional spring are connected with a shaft base and the rotating member respectively. The pivot device further comprises a lock element being connected to a second end, which is opposite to the first end. The rotating element is connected with a display module, and the assembly structure is connected with a supporting frame.

In one embodiment, the assembly structure is a shaft base, a pad, or the combination thereof The assembly structure has a plurality of the positioning holes. One of the positioning holes is formed on the shaft base and another one of the positioning holes is formed on the pad.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1 is a perspective view of the pivot device for a base of the present invention;

FIG. 2 is a perspective view of the pivot device of the present invention;

FIG. 3 is a perspective view of the pivot device and the assembly structure of the present invention;

FIG. 4 is an exploded perspective view of the pivot device of the present invention; and

FIG. 5 is a perspective view of the shaft and the assembly structure in accordance with another embodiment of the present invention.

### DETAILED DESCRIPTION OF THE PREFERRED EMBODIMENT

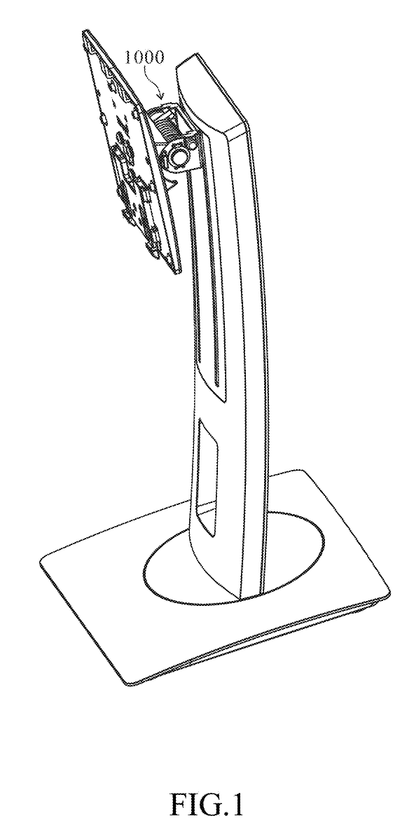

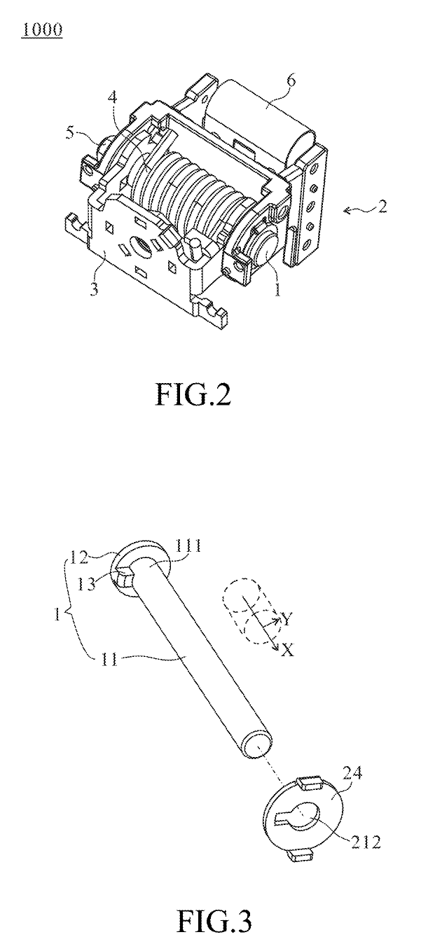

With reference to FIG. 1, a pivot device 1000 of the present invention is adapted to use in a supporting frame to support a display module. With reference to FIG. 2, the pivot device 1000 comprises a shaft 1, an assembly structure 2, a rotating element 3, a torsional spring 4 and a lock element 5. The assembly structure 2 is provided for the shaft 1 to penetrate through. The rotating element 3 is pivoted on the shaft 1 to rotate along the shaft 1 to an angle with respect to the assembly structure 2. The torsional spring 4 is pivoted on the shaft 1 and two ends of the torsional spring 4 are connected with the assembly structure 2 and the rotating element 3 respectively. After the shaft 1 passing through the assembly structure 2, the rotating element 3 and the torsional spring 4 sequentially, the shaft 1 is secured on the assembly structure 2 through the lock element 5. The rotating element 3 is adapted to connect with the display module. When the rotating element 3 rotates, the torsional spring 4 is driven by the rotating element 3 to generate a torsional force to maintain the display module staying at a view angel. The assembly structure 2 is connected with the supporting frame (a constant force spring 6 of the supporting frame leans on the assembly structure 2, as shown in FIG. 2). The detailed structure of the shaft 1 will be disclosed in detail hereinbelow.

With reference to FIG. 3 (the view angle of FIG. 3 is different from FIG. 2 for the convenience of description), the shaft 1 comprises a body 11, a head 12 and a protrusion 13. The body 11 extends along an axial direction X and has a first end 111. The body 11 has a circular body cross-section along a radial direction Y, which is perpendicular to the axial direction X. That is to say, the body 11 is a cylinder. The protrusion 13 is formed on the body 11 and adjacent to the first end 111. The body 11 and the protrusion 13 collaboratively form an end cross-section along the radial direction Y, and the end cross-section is non-circular. The protrusion 13 connects with the head 12. The head 12 has a head cross-section along the radial direction Y. Particularly, the head cross-section is greater than the body cross-section so that the head 12 plays a role of stopper.

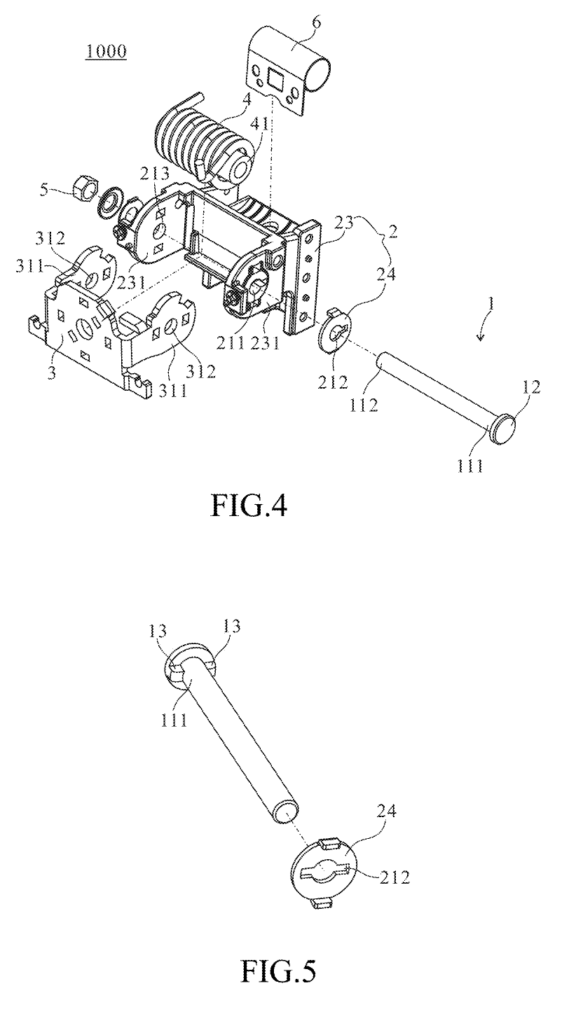

With reference to FIG. 4, in the present embodiment, the assembly structure 2 has a shaft base 23 and a pad 24. The shaft base 23 is a U-shaped board, which has two opposite side boards 231, a circular shaft hole 213 and a positioning hole 211. The circular shaft hole 213 and the positioning hole 211 are formed on the side boards 231 of the shaft base 23 respectively. On the other hand, a positioning hole 212 is formed on the pad 24 and the pad 24 is engaged with one of the side boards 231 of the shaft base 23 so that the positioning hole 212 is corresponding to the positioning hole 211. Both of the positioning hole 211 and the positioning hole 212 are non-circular holes. The function of the positioning holes 211 and 212 will be described in detail hereinbelow. In addition, the pad 24 could be made of a material with the high-strength properties so as to improve the strength of the pad 24.

The rotating element 3 is also U-shaped and has two opposite side boards 311 and two circular shaft holes 312 formed on the side boards 311 respectively. The side boards 311 are clamped between the side boards 231 of the shaft base 23. The two circular shaft holes 312 are corresponding to the circular shaft hole 213 and the positioning hole 211, respectively.

The torsional spring 4 is located between the side boards 311 of the rotating element 3 and has a shaft cover 41. When the body 11 passes through the positioning hole 212, the positioning hole 211, the circular shaft hole 312, the shaft cover 41 of the torsional spring 4 and the circular shaft hole 213 sequentially, the lock element 5 is locked on a second end 112 opposite to the first end 111. The head 12 abuts against the pad 24. In the present embodiment, the lock element 5 can be a nuts set. However, other elements with lock function can be applied in other embodiments of the present invention and is not restricted.

With reference to FIG. 3 and FIG. 4, the positioning hole 211 and the positioning hole 212 are complementary to the end cross-section collaboratively formed by the first end 111 of the body 11 and the protrusion 13. That is to say, a cross-section defined by the positioning hole 211 and the positioning hole 212 is a combination of a circle and a rectangle. When the pivot device 1000 is assembled, the first end 111 of the shaft 1 and the protrusion 13 are engaged within the positioning hole 211 and the positioning hole 212 so as to restrict the shaft 1 at a position.

Still with reference to FIG. 3 and FIG. 4, when the shaft 1 is positioned on the assembly structure 2, the rotating element 3 is able to rotate along the shaft 1 because of the round shape of circular shaft hole 312. The torsional spring 4 is twisted along the shaft 1 by the rotating of the rotating member 3. In consideration that the positioning hole 211 may be damaged due to the torsional force applied to the rotating shaft 1, material with high-strength may be selected for the pad 24 to improve the strength thereof

It should be noted that the assembly structure 2 has the shaft base 23 and the pad 24 in the above-mentioned embodiment. However, in other embodiments, the assembly structure could only have at least one of the shaft base and the pad. In other embodiments of the present invention, the shaft 2 comprises a plurality of protrusions. For example, as shown in FIG. 5, the assembly structure 2 has only one pad 24 and two protrusions 13, which are formed on the body 11 of the shaft 1 and adjacent to the first end 111, in the other embodiment of the present invention. The positioning hole 212 of the pad 24 is complementary to the end cross-section formed by the body 11 and the protrusions 13. Moreover, in other embodiments of the present invention, a plurality of protrusion 13 can be formed and asymmetrically distributed over the periphery of the first end 111. In conclusion, most of the body 11 of the shaft 1 is cylindrical along the axial direction X and the at least one protrusion 13 is formed on the first end 111 merely. That is to say, in the initial assembling process, the cylindrical body 11 can penetrate through the positioning hole 211 and the positioning hole 212 directly without paying too much attention for the alignment. Then the protrusion 13 can be engaged with the corresponding hole so as to save manufacturing time of assembling the pivot device 1000. Even though the locations of the circular shaft hole 213 and the positioning hole 211 are deviated to each other, it is still easy for the body 11 aligning and penetrating through the holes since the holes are circular. Moreover, in comparison to the conventional shaft which is further treated by a cutting process, the protrusion 13 in the present invention can be simultaneously formed in the pressing process of forming the body 11 of the shaft 1 so that the manufacturing time and cost of the pivot device 1000 can be saved in the present invention.

The above disclosure is related to the detailed technical contents and inventive features thereof People skilled in this field may proceed with a variety of modifications and replacements based on the disclosures and suggestions of the invention as described without departing from the characteristics thereof Nevertheless, although such modifications and replacements are not fully disclosed in the above descriptions, they have substantially been covered in the following claims as appended.

What is claimed is:

1. A shaft for being disposed through an assembly structure, the assembly structure having at least one positioning hole, the shaft comprising:
a body, extending along an axial direction and having a first end, the body having a circular body cross-section along a radial direction which is perpendicular to the axial direction;
a head, connecting with the first end and having a head cross-section along the radial direction, wherein the head cross-section is larger than the body cross-section; and
at least one protrusion, being formed on the body and adjacent to the first end;
wherein the body and the protrusion form an end cross-section along the radial direction, and the end cross-section is non-circular and complementary to the positioning hole.

2. The shaft as claimed in claim 1, wherein the shaft comprises a plurality of the protrusions.

3. The shaft as claimed in claim 1, wherein said protrusion is connected with the head.

4. A pivot device comprising:
a shaft comprising:
a body, extending along an axial direction and having a first end, the body having a circular body cross-section along a radial direction which is perpendicular to the axial direction;
a head, connecting with the first end and having a head cross-section along the radial direction, wherein the head cross-section is larger than the body cross-section; and
at least one protrusion, being formed on the body and adjacent to the first end, wherein the body and the protrusion form a non-circular end cross-section along the radial direction;
an assembly structure, having at least one positioning hole for the shaft to be disposed through, wherein the at least one positioning hole and the end cross-section are complementary; and
a rotating member, being pivoted on the body to rotate along the body to an angle with respect to the assembly structure.

5. The pivot device as claimed in claim 4, wherein the shaft comprises a plurality of protrusions.

6. The pivot device as claimed in claim 5, further comprising a torsional spring being pivoted on the body, wherein two ends of the torsional spring are connected with a shaft base and the rotating member respectively.

7. The pivot device as claimed in claim 4, further comprising a lock element being connected to a second end opposite to the first end.

8. The pivot device as claimed in claim 4, wherein the rotating member is connected with a display module, and the assembly structure is connected with a supporting frame.

9. The pivot device as claimed in claim 6, wherein the assembly structure is a shaft base, a pad, or the combination thereof

10. The pivot device as claimed in claim 9, wherein the assembly structure has a plurality of the positioning holes and one of the positioning holes is formed on the shaft base.

11. The pivot device as claimed in claim 9, wherein the assembly structure has a plurality of the positioning holes and one of the positioning holes is formed on the pad.
